(19) United States
(12) Patent Application Publication
(10) Pub. No.: US 2018/0071841 A1
(43) Pub. Date: Mar. 15, 2018

(54) MACHINE FOR CRUSHING AND SHEARING METAL CASTING DEBRIS

(71) Applicant: Kodiak Group, LLC, Grayling, MI (US)

(72) Inventors: Steven M. Kassuba, Gaylord, MI (US); Howard R. Wood, Gaylord, MI (US)

(21) Appl. No.: 15/705,488

(22) Filed: Sep. 15, 2017

Related U.S. Application Data
(60) Provisional application No. 62/394,911, filed on Sep. 15, 2016.

(51) Int. Cl. B23D 35/00; B23D 31/00

(52) U.S. Cl. CPC B23D 35/002; B23D 31/008; B23D 35/001

(57) ABSTRACT

A machine that applies both cutting and shearing action to casting-type metal debris and scrap (hereafter “debris”), and thus efficiently reduces both brittle and ductile metals to a useful size. The machine comprises a fixed anvil and a reciprocating jaw, the anvil defining an array of spaced anvil plates and the jaw defining a complementary array of spaced jaw V-shaped jaw bars whose upper and lower legs or lobes are alternately reciprocated in an arc into and out the anvil plate array.

### RELATED APPLICATIONS/PRIORITY BENEFIT CLAIM

This application claims the benefit of U.S. Provisional Application No. 62/394,911, filed Sep. 15, 2016 by the same inventors (Kassuba and Wood), the entirety of which provisional application is hereby incorporated by reference.

### FIELD

The subject matter of the present application is in the field of machines for “comminuting” or reducing scrap metal pieces to a useful size for reuse, in particular debris or material left over from casting operations.

### BACKGROUND

Specialized machines are commonly used for breaking irregular metal debris left over from casting operations into smaller pieces. Examples of such debris include sprue gating, cast weirs, ingates, runners, and scrap castings, and those skilled in the art will be familiar with similar types of metal debris that may usefully be reduced in size with such machines.

Some of these machines use a reciprocating plate acting against another plate to crush or break material; other machines use shearing blades. In either case it is desirable to prevent the debris being crushed or sheared from exiting the machine before it is reduced into sufficiently small pieces to be useful.

One prior machine is shown in U.S. Pat. No. 6,827,301 to Kassuba, in which a moveable plate or “jaw” faced with hardened projections is reciprocated against a moveable plate with hard stops and complementary projections. During loading and crushing cycles the lower ends of the plate-like jaw members are held close to each other so that the debris being crushed is largely prevented from falling out from between them at the lower end. The action of this machine can be described as primarily crushing or breaking.

Another such machine is shown in Swiss Patent No. CH656325 A5 to Otto, in which a movable array of spaced blade-like cutter bars is reciprocated into and out of engagement with a complementary fixed array of cutter bars, similar to scissor blades. A closed pivot structure at the interconnected lower ends of the linked cutter bars prevents debris from falling through. The debris-reducing action of this machine can be described as primarily by shearing.

Cast metal debris and similar metal scrap pieces may include both brittle and ductile materials of varying size and shape, some of which are more effectively reduced in size by crushing/breaking, and some of which are more effectively reduced in size by shearing.

### BRIEF SUMMARY

The present invention is a machine that applies both crushing and shearing action to casting-type metal debris and scrap (hereafter “debris”), and thus efficiently reduces both brittle and ductile metals to a useful size.

The machine uses a reciprocating jaw member and a stationary anvil member, and achieves uniform reduction of the scrap pieces to a desirable size by providing a dynamically sized exit for debris from the work area between the anvil and jaw during the work cycle. The reciprocating jaw comprises an array of spaced, parallel, generally vertical-plane plates or bars (hereafter “bars”) on a movable horizontal support beam or drum, the bars having generally planar, V-shaped configurations with upper and lower legs or lobes defining a “mouth” opening toward the anvil and converging toward a vertex at the base of the jaw bar. The fixed anvil comprises a complementary array of spaced, parallel, generally vertical-plane plates fixedly mounted on the machine opposite the jaw. The movable jaw reciprocates the jaw bars between the anvil plates.

In a further aspect of the invention, the jaw bars reciprocate through the anvil plates in a short arc between open and closed positions. In the jaw open position, the lower lobes of the jaw bars reduce the debris exit area between the anvil plates, partially blocking them; in the jaw closed position, the lower lobes of the jaw bars are rotated out of the anvil plate array, enlarging the debris exit area between the anvil plates, while the upper lobes of the jaw bars are rotated into the anvil plate array.

In a further form, the jaw reciprocates on a pivot axis offset rearwardly from the work area defined between the jaw and anvil.

In a further form, the upper or leading edges of the anvil plates are sloped downwardly and inwardly toward the work area defined between the jaw and anvil. In one form the upper edges of the anvil plates are straight to define an upper work plane through which the V-shaped jaw bars reciprocate.

V-shaped should be understood to mean a shape generally having upper and lower ends or lobes with work-engaging edges projecting in diverging manner toward the anvil from a recessed vertex or base. The work-engaging edges are preferably squared or truncated at their junction and transition points, rather than pointed or smoothly radiused. V-shaped should be considered to include generally C-shaped or sideways U-shaped bar configurations, especially where the work-engaging edges diverge and where transition points are squared or angled rather than smoothly rounded.

The jaw may optionally be provided with supplemental crushing/shearing members, gripping projections, or angular contours (hereafter generally “teeth”) located on the jaw bars and/or between the jaw bars. In one embodiment the supplemental teeth are located on the inner opposing faces of the jaw bar work-engaging edges near the bar's vertex or base. In another embodiment teeth may be provided on the surface of the support drum between the jaw bars.

These and other features and advantages of the invention will become apparent from the detailed description below, in light of the accompanying drawings.

### BRIEF DESCRIPTION OF THE DRAWINGS

FIG. 1 is an upper perspective view of an example machine according to the invention, with the jaw in an open position relative to the anvil.

FIG. 2 is similar to FIG. 1, but with the jaw in a closed position relative to the anvil.

FIG. 3 is a side elevation view of the machine of FIG. 1, with the jaw in the open position of FIG. 1.

FIG. 4 is a side elevation view of the machine of FIG. 1, with the jaw in the closed position of FIG. 2.

FIG. 5 is a top plan view of the machine of FIG. 1, with the jaw in the open position of FIG. 1.

FIG. 6 is a top plan of the machine of FIG. 1, with the jaw in the closed position of FIG. 2.

FIG. 7 is a bottom plan view of the machine of FIG. 1, with the jaw in the open position of FIG. 1.

FIG. 8 is a bottom plan view of the machine of FIG. 1, with the jaw in the closed position of FIG. 2.

FIG. 9 is a front perspective view of a modified machine according to the invention, with the jaw in a closed position.

FIG. 10 is a rear perspective view of the machine of FIG. 9, with the jaw in an open position.

FIG. 11 is a side elevation view of the machine of FIG. 9, with the jaw in an open position.

FIG. 12 is a side elevation view of the machine of FIG. 9, with the jaw in a closed position.

FIG. 13 is a side elevation view of the machine of FIG. 9, with the jaw being disassembled from the machine for repair or replacement.

FIG. 14 is a front perspective view of the jaw support cradle or main blade structure, with an individually attached jaw bar exploded away.

### DETAILED DESCRIPTION

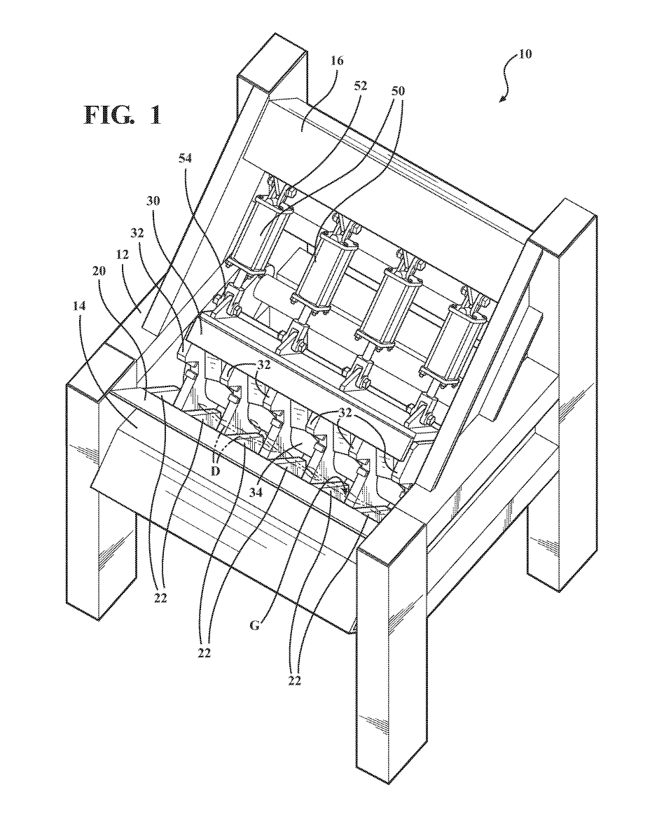

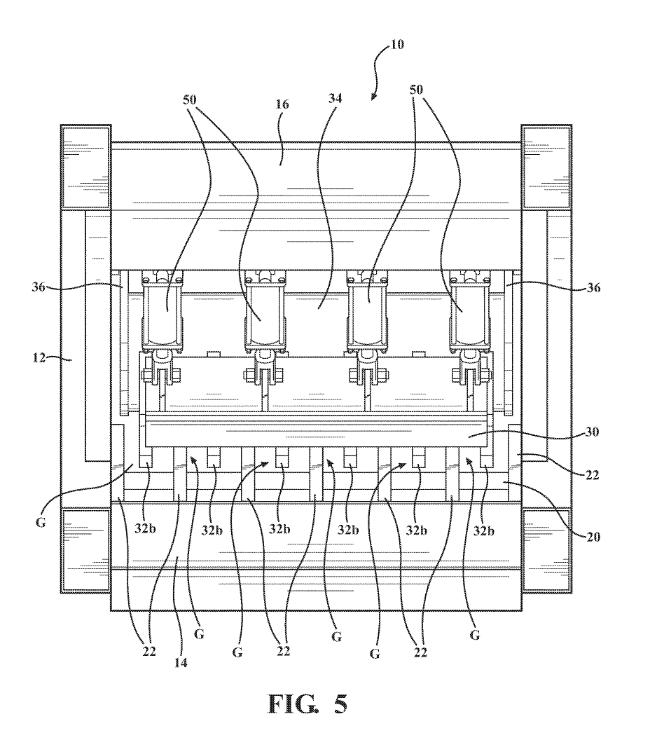

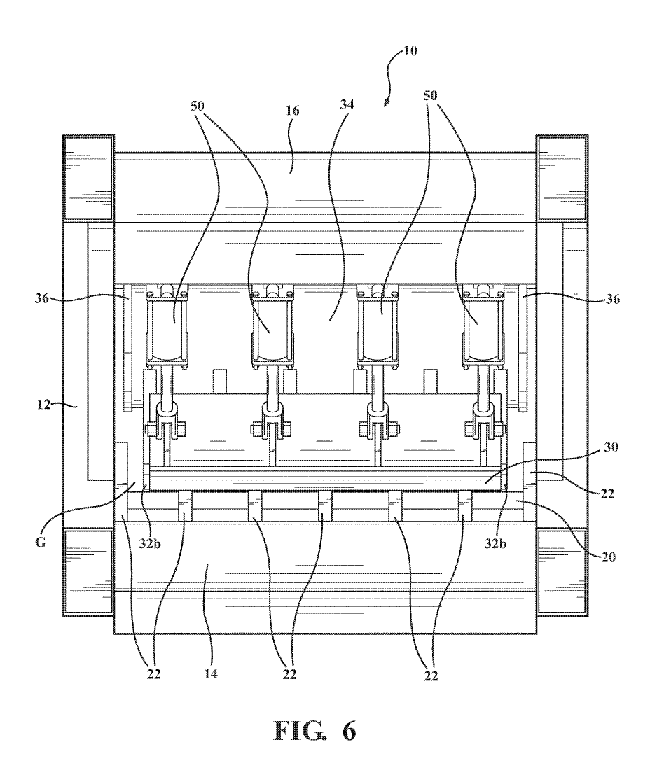

Referring generally to FIGS. 1-8, a machine 10 is shown in exemplary form in order to teach how to make and use the claimed invention. Machine 10 includes a frame 12, a fixed anvil 20, and a movable jaw 30. Anvil 20 includes an array of parallel spaced plates 22 mounted on a fixed backer plate 24 secured to a support beam 14 on machine 10. Jaw 30 includes a complementary array of parallel spaced bars 32 mounted on a horizontal support such as a beam or drum 34, opposing and laterally offset from the anvil plates 22 such that the plane of each jaw bar 32 is centered in the space between two adjacent anvil plates 22 with a uniform gap G on either side.

As is known in the art, the main load-bearing and metal-crushing/shearing components of machine 10 are preferably made from a hard and/or durable material such as steel. For example, anvil plates 22 and jaw bars 32 may be made from hardened steel with additional hard-facing of known type applied to their outer, debris-engaging surfaces. Frame 12 of machine 10 is likewise preferably made primarily from steel. Mild steels, some aluminum alloys, and various bronze alloys or polymers may be suitable for lighter frame components, supports, pivot bearings, and the like. Connections between the various parts, when they are not integrally machined or cast, can be made using welds, industrial adhesives, and/or mechanical connectors, as will also be recognized by those skilled in the art.

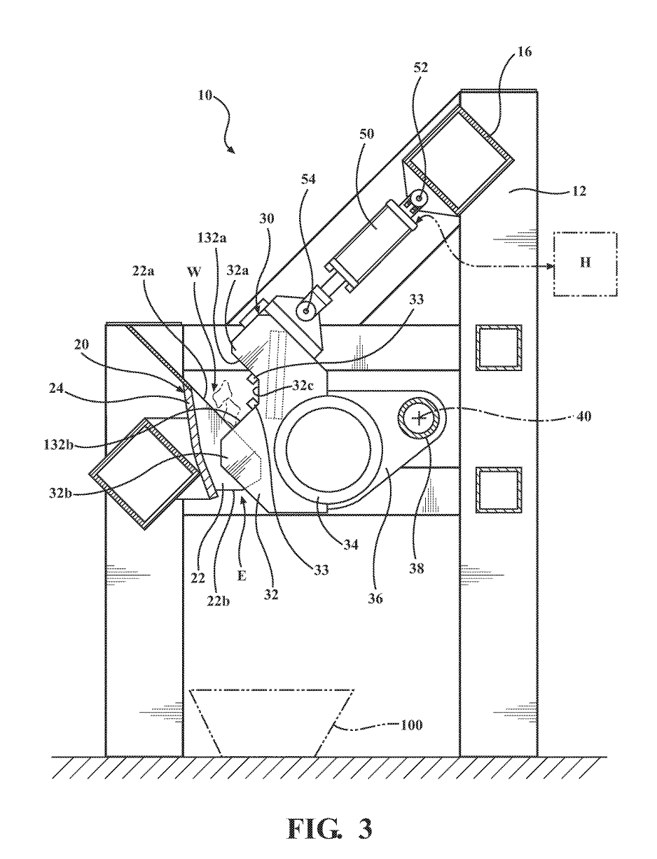

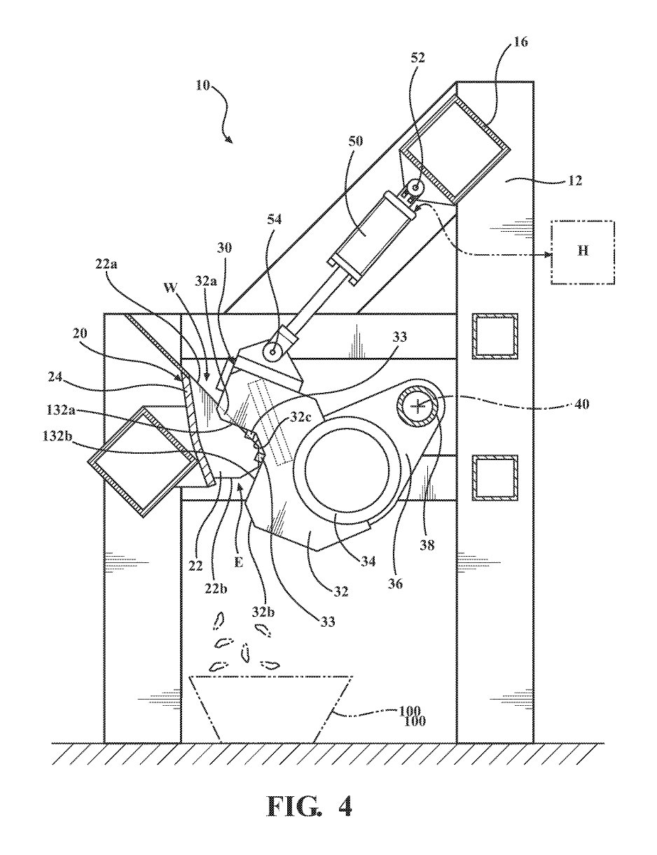

Jaw 30 is reciprocated in an arc on a shaft 38 about a pivot axis 40 (shown in FIGS. 3 and 4) by one or more actuators 50 located rearwardly and above the jaw on machine 10. Pivot shaft 38 is located rearwardly of jaw support 34 on the machine, connected by link arms or plates 36 extending from the respective ends of the drum 34 to the pivot shaft 38. In the illustrated example, actuators 50 comprise one or more linear-acting hydraulic pistons of known type pivotally connected to an upper fixed support beam 16 on frame 12 at one end 52, and pivotally connected to jaw 30 at the other end 54. When jaw 30 is reciprocated toward and away from anvil 20 on the pivot axis, jaw bars 32 are reciprocated in an arc through the spaces between anvil plates 22.

Actuators 50 may take different forms, including but not limited to one or more pneumatic pistons of known type, or a reversible electric or hydraulic motor of known type connected to rotate the jaw directly through pivot shaft 38 on axis 40, without limitation, with jaw 30 reciprocated in an arc through the anvil 20 through a pivot axis spaced rearwardly from the jaw. The manner in which motive power is applied to operate the actuators 50 can vary, and in the illustrated example can be a conventional hydraulic fluid supply and return system schematically shown at H in FIG. 3, located on or off the machine 10. While a large diameter round support drum 34 is shown in the illustrated example as the horizontal support for the jaw bars 32 in jaw 30, the diameter and cross-sectional shape of the support 34 may vary, for example a square-sectioned beam. Also, the pivot location 40 and its spacing from jaw 30 may vary depending on the size of the debris being reduced.

FIGS. 1, 3, 5, and 7 show jaw 30 in its open or raised position in which work area W between the jaw and anvil is open to receive a load of metal debris D. The maximum exit area E for debris from work area W is defined by the sum of the spaces or gaps G between the anvil plates 22 (plus some lesser spacing between anvil backer plate 24 and the outer free ends 32b of jaws 32 and between support drum 34 and the outer free ends of plates 22). Debris falls by gravity through the spaces between the anvil plates to a waiting collection point or receptacle 100 after it has been reduced to a small enough size. In the illustrated example, gaps G are on the order of 1″ to 3″ (inches) in width, and on the order of 8″ to 12″ in length, but it will be understood that the size of gaps G and/or the length of the anvil plates (and thus the exit area for the reduced debris) may vary depending on the desired reduced size of the debris.

In the jaw open position, the upper lobes 32a and upper work-engaging edges 132a of jaw bars 32 are disengaged from anvil plates 22, i.e. raised above the plane of the upper edges 22a of anvil plates 22. The lower lobes 32b and lower work-engaging edges 132b of the jaw bars are engaged or interleaved with anvil plates 22, i.e. lower lobes 32b are lowered below the plane of the upper edges 22a and located at least partially between the anvil plates 22 and lower work-engaging edges 132b are intersecting the plane of the upper edges 22a of the anvil plates.

In this jaw open position, at least one dimension of the debris in work area W must be smaller than the spacing between lower lobes 32b of jaw plates 32 and the adjacent pair of anvil plates 22 (or between the outer ends of lobes 32b and the backer plate 24) in order to fall through exit area E to a waiting collection point 100 such as a hopper or conveyor.

It will further be understood that the gap or space between the outer ends of lower lobes 32b of the jaw bars and the backer plate 24 behind the anvil plates 22 forms part of the total exit area E, but this dimension is preferably sized to be less than the side-to-side spacing G between interleaved bars 32 and plates 22 so that G is the controlling dimension in terms of debris reduction.

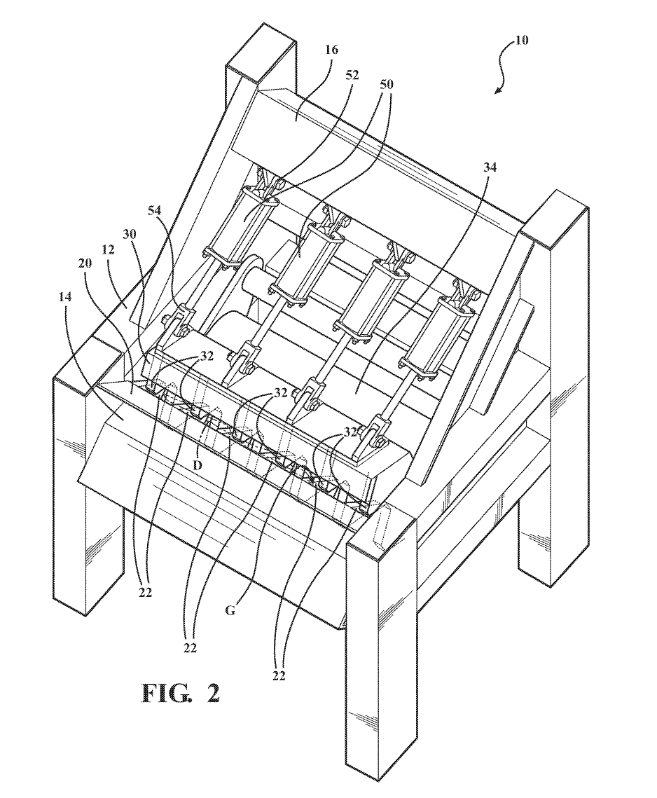

FIGS. 2, 4, 6, and 8 show jaw 30 in its closed position in which it has rotated on an arc partway through anvil 20. In the jaw closed position, the lower lobes 32b and lower work-engaging edges 132b of the jaw bars 32 are disengaged from anvil plates 22, i.e. lower lobes 32b are free and clear of the lower edges 22b of the anvil plates, i.e. no longer interleaved between the anvil plates but rotated below the anvil. The upper lobes 32a and upper work-engaging edges 132a of jaw bars 32 are engaged or interleaved with anvil plates 22, i.e. upper lobes 32a are lowered below the plane of the upper edges 22a and located at least partially between the anvil plates and upper work-engaging edges 132a are intersecting the plane of the upper edges 22a of the anvil plates.

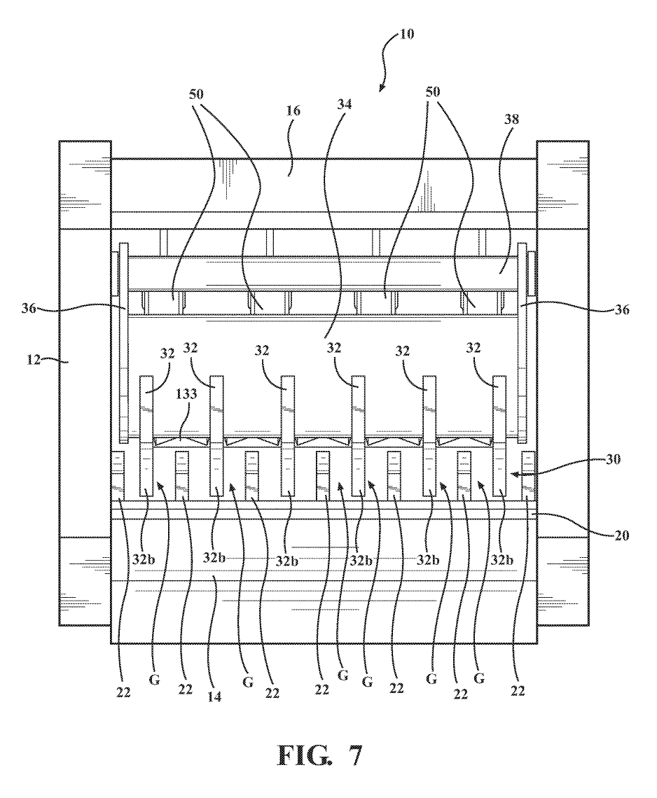

It will further be understood that the gap or space between the outer free ends of anvil plates 22 and the drum 34 or any supplemental teeth such as 33 (or 133 as shown in FIG. 7) located between the jaw bars 32 on jaw 30 forms part of the total exit area E. However, this dimension is preferably sized to be less than the side-to-side spacing between adjacent plates 22, and also preferably less than the gap G between lower lobes 32b and plates 22 when the jaw is in the open position with lobes 32b between the plates, so that G is the controlling dimension in terms of debris reduction.

In this jaw closed position, at least one dimension of the debris in work area W must be smaller than the spacing (G+G+the thickness of lobe 32b) between any two adjacent anvil plates 22 in order to fall through exit area E to a waiting collection point 100. It will be understood that the upper lobes 32a of the jaw plates serve not only to break and shear debris that is still too large to pass through the machine, but to help drive the reduced debris through the anvil plates 22 to the collection point 100, helping to prevent jams.

The work cycle of jaw 30 through anvil 20 is accordingly a short down-and-up reciprocating arc, for example traveling through an arc of about 15-30° (degrees). The angle and spacing of the upper and lower ends and respective work-engaging edges of the jaw bars 32, and the arc of travel of the jaw 30 through a work cycle, are configured so that even irregular debris of varying hardness is efficiently crushed and sheared in work area W.

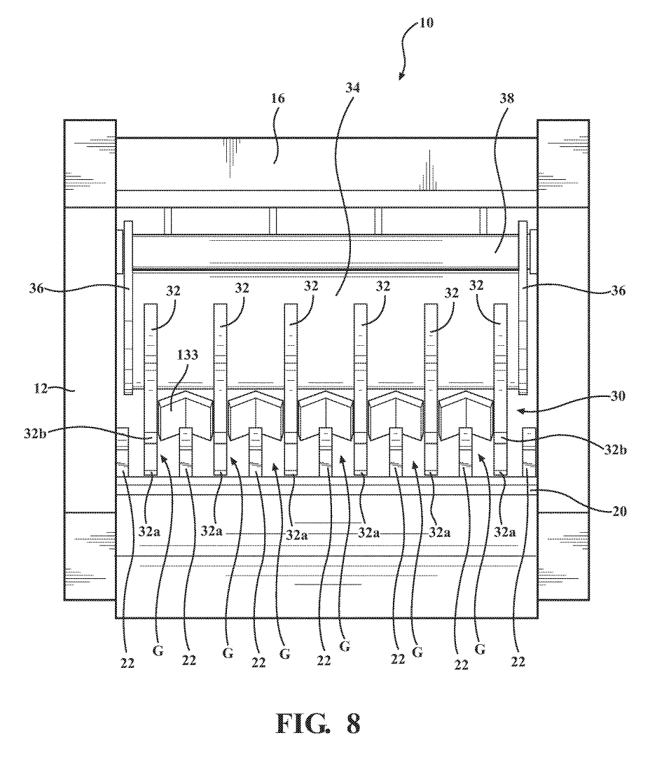

FIGS. 3 and 4 show supplemental debris-reducing teeth 33 formed as rectangular blocks of hardened steel on the work-engaging edges 132a and 132b of jaw plates 32. FIGS. 7 and 8 show an alternate type of debris-reducing teeth 133 in the form of angled plates of hardened steel on the face of drum 34 between jaw plates 32. Both types of teeth 33 and 133 served to help crush the debris by engaging it with intersecting angular faces rather than rounded or smooth surfaces that would tend to slide over debris trapped at the vertices of the jaw plates and/or between the ends of the anvil plates and the face of the drum. Other forms of debris-engaging teeth may be used in these or other locations, as well, to disrupt any smooth sliding contact areas between debris and the interacting work surfaces of the machine, as needed or desired.

It will be understood that while anvil 22, jaw 30, and actuators 50 are shown integrated into machine 10 with a common frame 12, it may be possible or desirable in some circumstances to separately mount one or more them. For example, anvil 22 might be mounted on a fixed support structure such as a wall or pedestal while jaw 30 and actuators 50 are mounted on an adjacently positioned frame 12. Actuators 50 might be mounted on a support structure separately from but adjacent frame 12 on which jaw 30 and anvil 22 are integrated.

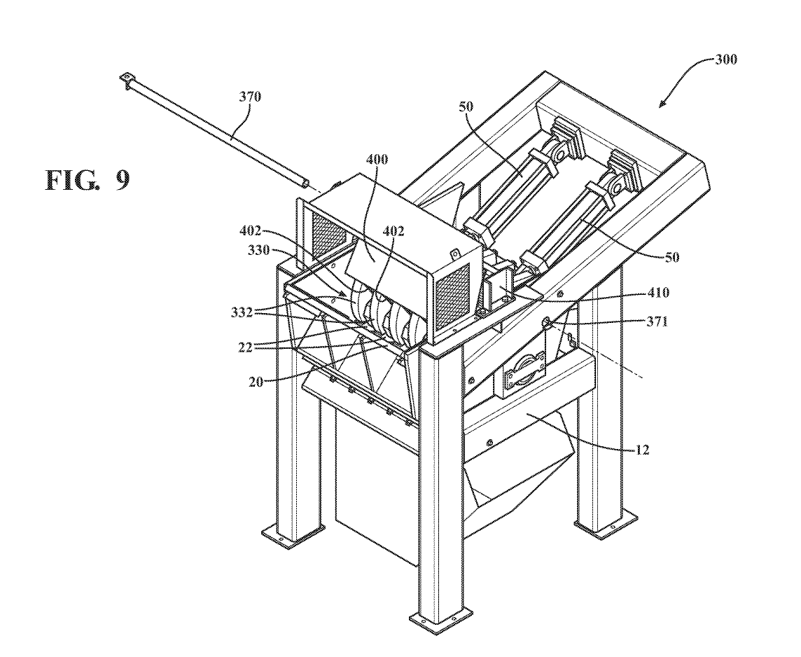

Referring now to FIGS. 9 through 14, a modified form of machine 10 is shown at 300, in which the contour and structure of the jaw has been modified to better crush and shear debris between the jaw and anvil, and in which a jaw-cleaning rake or comb has been added to prevent debris build-up between the jaw bars.

FIGS. 9-14 show machine 300 with a jaw 330 similar to jaw 30 above, comprising an array of spaced jaw bars 332 with upper and lower lobes 332a and 332b having diverging work-engaging leading edges 331. Jaw bars 332 function in a manner similar to those in jaw 30, reciprocating in a short arc between the anvil plates 22 of anvil 20 on a pivot axis spaced rearwardly of the interacting work surfaces.

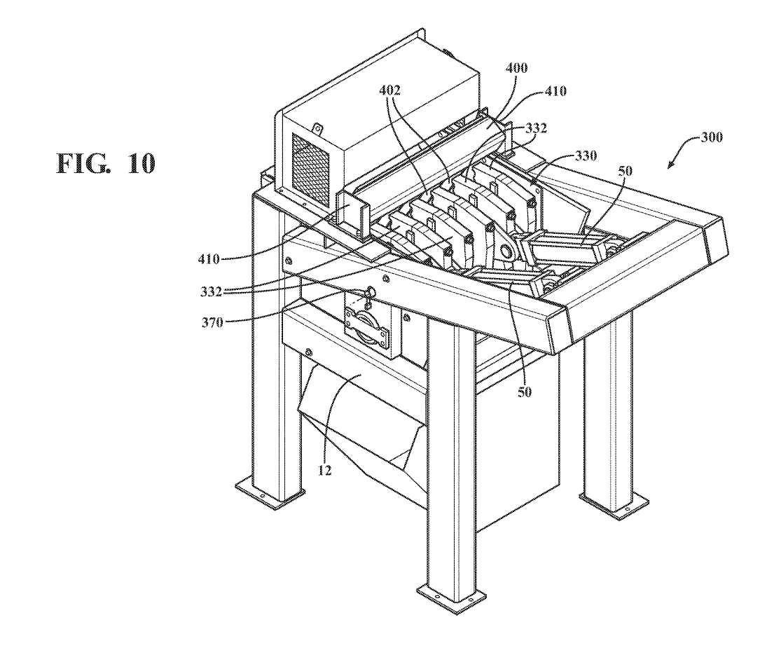

Machine 300 is shown with two rather than four hydraulic actuators 50, but these function in a manner similar to that described above to reciprocate jaw 330 through the anvil. FIG. 9 shows jaw 330 rotated down into the closed crushing/shearing position, while FIG. 10 shows jaw 330 rotated up and back to the open debris-loading position. FIGS. 9 and 10 also show a jaw locking bar or rod 370 inserted through aligned holes 371 in jaw 330 and sides of frame 12 when the jaw is in the open position of FIG. 10, in order to positively lock the jaw in the open position.

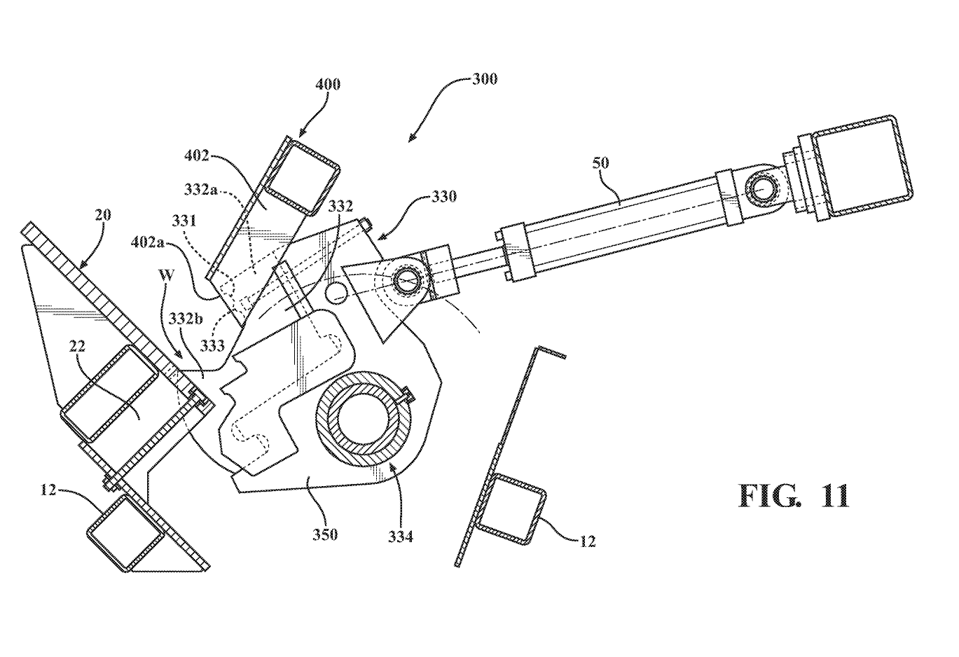

Machine 300 includes an upper rake or comb 400 located above jaw 330. Comb 400 comprises an array of spaced parallel bars or plates 402 aligned between the upper lobes 332a of jaw bars 332. The upper lobes of the jaw bars 332 accordingly reciprocate at least partially, and preferably fully, between plates 402 when jaw 300 is rotated rearwardly to the open debris-loading position shown in FIGS. 10 and 11. Comb plates 402 remove any debris trapped between the jaw bars, deflecting the debris back down into work area W where it can be crushed or sheared on the next downward stroke of the jaw.

As best shown in FIG. 11, comb plates 402 preferably have leading edges 402a angled rearwardly at an acute angle from vertical, less than ninety degrees, to approximate the angle of the leading edge 331 of upper lobe 332a when the jaw is fully open. This angular orientation fully clears debris from the jaw.

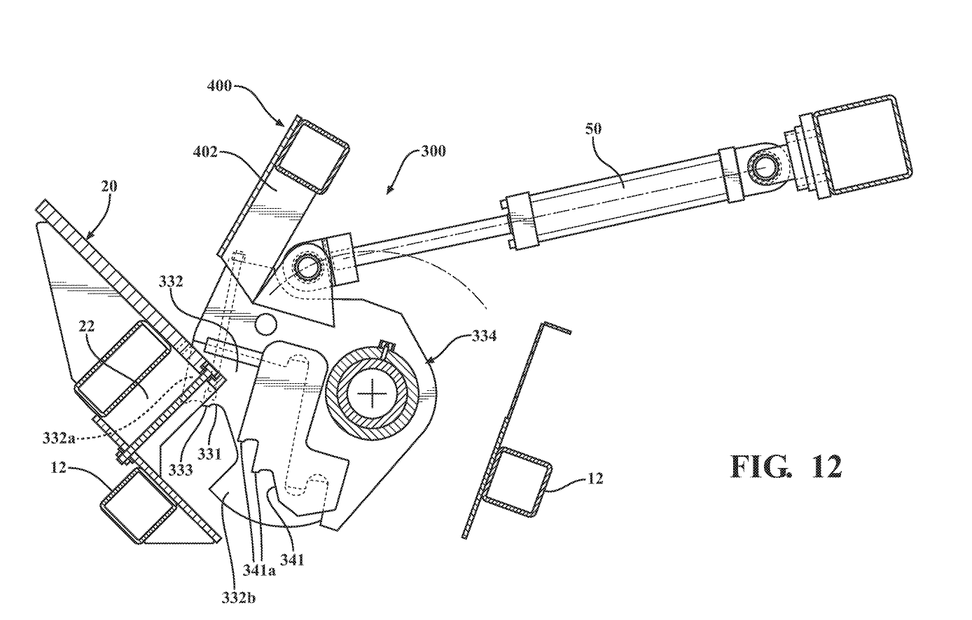

Referring next to FIGS. 11 and 12, the structure of a representative jaw bar 332 on jaw 330 can be seen in its open and closed positions, respectively. Jaw bar 332 includes teeth-like features 333 protruding from the leading edge 331 of upper lobe 332a, and a pair of multi-angled or toothed cheek plates 340, one cheek plate secured to each side face of the jaw bar. Each cheek plate 340 has an irregular, multi-angled leading edge 341 located behind the leading work edges 331 of jaw bar 330, and associated with the lower half of the jaw bar, i.e. primarily in the region of lower lobe 332b. Irregular leading edge 341 may include teeth-like projections 341a at spaced locations, and helps to further crush and shear debris located between jaw plates 332.

Upper lobe teeth 333 may be integrally formed on the leading edge 331 of the jaw bar as shown, or may be formed as short bars or similar pieces attached or formed on the side faces of the upper lobe and projecting forwardly beyond the leading edge 331.

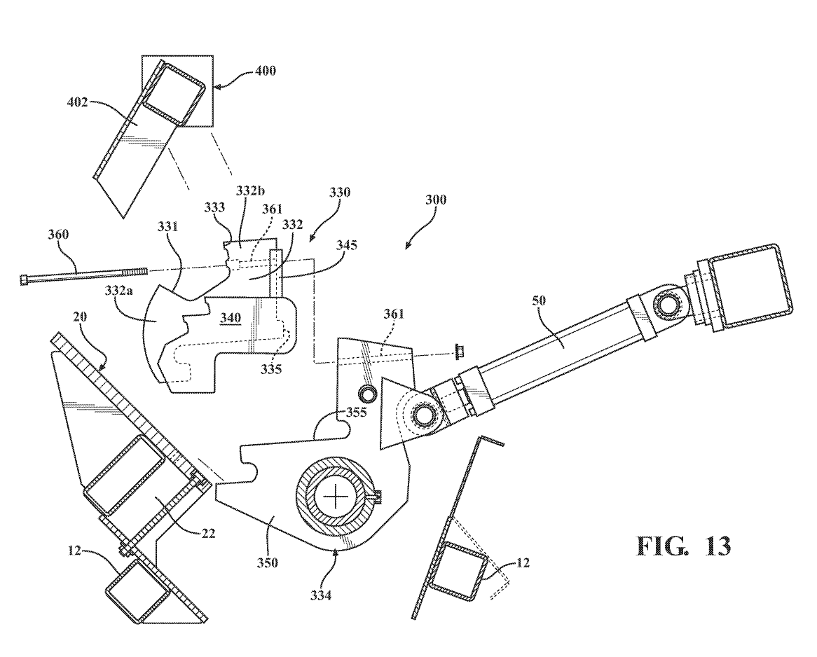

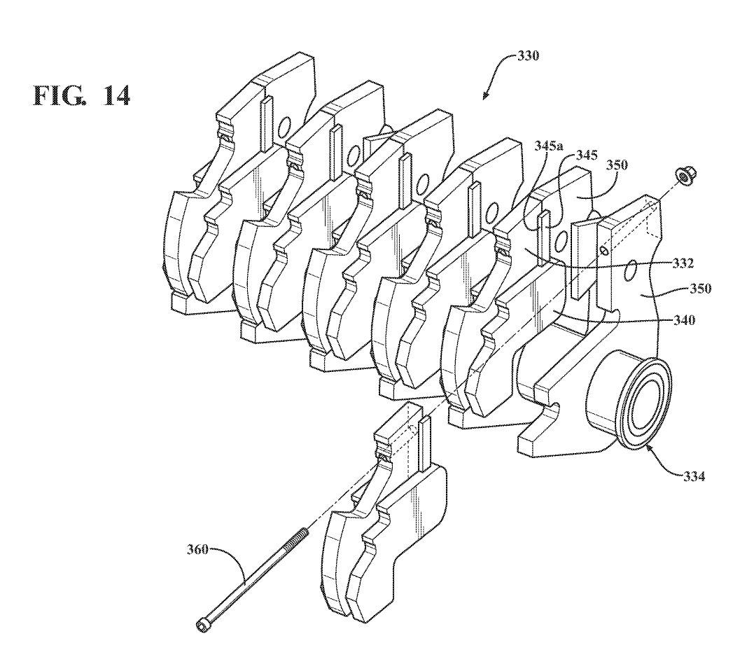

Referring now to FIGS. 13 and 14, jaw bars 332 of jaw 330 are preferably individually detachable from jaw support 334, or more specifically from each of multiple support plate sections 350 spaced along the length of drive shaft 38 to rotate with the shaft. The rear edge 335 of each jaw bar has a contour and width approximating or matching a leading edge contour 355 of the associated support plate 350, in order to mate closely with the support plate section 350. The jaw bar is removably locked to the cradle plate with a retainer bolt 360 or similar passing through both structures. If a jaw bar 332 becomes worn or damaged, removing the retainer bolt 360 allows the jaw bar 332 and its integrated cheek plates to be removed as a unit from jaw support 334. While the illustrated retainer bolt is a preferred method of attaching the jaw bar to the support plate, other types of connection could be used.

The junction of each jaw bar 330 and its associated support plate 350 may be overlapped by a plate or bar 345 with an angular forward edge 345a, connected to one or both for additional strength and for an optional extra comminuting surface.

FIG. 14 also shows comb 400 being removed from the machine for repair or replacement, for example by unbolting it from a pair of end-mounting brackets 410 located on the upper sides of frame 12 on machine 300 (best shown in FIGS. 9 and 10) that secure comb 400 above the jaw rearwardly of the comminuting work area.

### DESCRIPTION OF OPERATION

In operation, machine 10 is used by charging work area W between anvil 22 and jaw 30 with a load of debris D while the jaw is in the open position of FIGS. 1, 3, 5 and 7. Once charged, jaw 30 is reciprocated through a short arc in which lower lobe 32b traps oddly-dimensioned debris between or above plates 22 until upper lobe 32a can engage the debris to crush and/or shear it against and/or between anvil plates 22. The operation of machine 300 and its jaw 330 in FIGS. 9-14 is substantially the same.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention supported by the above disclosure should accordingly be construed within the scope of what it teaches and suggests to those skilled in the art, and within the scope of any claims that the above disclosure supports in this application or in any other application claiming priority to this application.

1. A machine for applying both cutting and shearing action to casting-type metal debris and scrap, comprising:
a jaw comprising an array of spaced parallel vertical-plane bars mounted on a rotatable horizontal jaw support, the bars having a generally V-shaped configuration comprising upper and lower lobes comprising leading work edges diverging toward the anvil and converging toward a vertex adjacent the rotatable horizontal jaw support;
a fixed anvil located opposite the reciprocating jaw, the fixed anvil comprising a complementary array of spaced parallel vertical plates fixedly mounted on the machine opposite the jaw; wherein,
the jaw is reciprocated by an actuator to reciprocate the jaw bars between the anvil plates in an arc.

2. The machine of claim 1, wherein the jaw bars are aligned evenly between adjacent anvil plates to define evenly sized comminuted debris gaps when the lobes of the jaw bars are located between the anvil plates.

3. The machine of claim 2, wherein the jaw has an open position relative to the anvil at an upper portion of the arc in which the lower lobes of the jaw bars are interleaved evenly between adjacent anvil plates and the upper lobes of the jaw bars are spaced above the anvil plates.

4. The machine of claim 3, wherein the jaw a closed position relative to the anvil at a lower portion of the arc in which the lower lobes of the jaw bars are substantially disengaged from the anvil plates to open a comminuted debris exit below the anvil, and in which the upper lobes of the jaw bars are substantially engaged with the anvil plates to crush and shear debris between the jaw and the anvil.

5. The machine of claim 1, wherein the actuator comprises a linear actuator located rearwardly of the jaw.

6. The machine of claim 1, wherein the rotatable horizontal support rotates on a pivot axis offset rearwardly from the work area defined between the jaw and anvil.

7. The machine of claim 1, wherein the machine comprises a debris-removing comb located above the jaw, the comb comprising an array of spaced parallel debris-removing members aligned between the upper lobes the jaw bars, the upper lobes of the jaw bars reciprocating at least partially between the debris-removing members of the comb when the jaw is rotated to its open position at the upper part of the arc.

8. The machine of claim 1, wherein the rotating horizontal jaw support comprises a plurality of spaced parallel support plates, and wherein the jaw bars are individually removably connected to the support plates.

9. The machine of claim 9, wherein the jaw bars comprise rear edges including contours matching contours of the leading edges of the support plates to mate therewith, and further wherein the jaw bars are removably connected to the support plates with one or more retainer bolts extending from a leading edge of the jaw bar through the rear edge of the jaw bar and through the leading edge of the support plate.

10. The machine of claim 1, wherein the jaw bars further comprise cheek plates secured to side faces of the jaw bars, the cheek plates comprising multi-angled leading edges located radially inwardly of the leading edges of the jaw bars.
